(19) United States
(12) Patent Application Publication
(10) Pub. No.: US 2005/0128347 A1
(43) Pub. Date: Jun. 16, 2005

(54) Tripod of image photographing apparatus

(75) Inventors: Kwan-Hyun Ryu, Seongnam-si (KR); Hee-Sun Tak, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/998,976

(22) Filed: Nov. 30, 2004

(30) Foreign Application Priority Data
Dec. 15, 2003 (KR) 2003-91268

(51) Int. Cl. H04N 5/225

(52) U.S. Cl. 348/375

(57) ABSTRACT

A tripod of an image photographing apparatus capable of rotating the image photographing apparatus, comprises a mount section to which the image photographing apparatus is attached, and a drive section for rotating the mount section. The mount section comprises a signal terminal for transmitting a signal of the image photographing apparatus to the drive section, and a power terminal for carrying power from the image photographing apparatus to the drive section. The tripod of the image photographing apparatus further comprises a record button for transmitting an image record signal to the image photographing apparatus and/or a zoom button for transmitting a lens zoom signal to the image photographing apparatus.

### CROSS-REFERENCE TO RELATED APPLICATIONS

This application claims priority under 35 U.S.C. §119(a) to Korean Patent Application No. 2003-91268, entitled “Tripod of Image Photographic Apparatus”, filed on Dec. 15, 2003 in the Korean Intellectual Property Office, the entire contents of which are hereby incorporated by reference.

### BACKGROUND OF THE INVENTION

1. Field of the Invention

The present invention generally relates to a portable image photographing apparatus for photographing an image in a moving or non-moving state. More particularly, the present invention relates to a tripod of an image photographing apparatus for supporting the image photographing apparatus to stand on a target surface, or aiding a user to take various photographing postures.

2. Description of the Related Art

A camcorder, which is a type of image photographing apparatus, is a portable device that photographs moving pictures. Because of its convenience, the camcorder has been used worldwide. In the event that a user needs to photograph herself with an image photographing apparatus such as a camcorder, or to fix the image photographing apparatus stably for still photographing, a tripod of the image photographing apparatus is most commonly used, since the tripod supports the image photographing apparatus to stand on a target surface with a high degree of stability.

A tripod having three legs is the most commonly used configuration for a camcorder's stability. Most conventional tripods are built with devices that enable users to control both the positioning height and angle of the camcorder. Therefore, use of tripod allows the camcorder to have consistently fixed height and shooting direction. Thus, it is possible to obtain consistent photographs of desired images by the camcorder. Once the shooting direction of the camcorder is fixed, however, the shooting direction does not change until the direction of the camcorder lens is changed by unlocking a fixation device on the tripod. Hence, in case that a target object moves, for example, from left and right with respect to the camcorder lens, it may be difficult to photograph the target object along the movement of the targeted object. Also, when the user wants to photograph a scene with a specific photographing feature such as a panorama technique that gives a wide view of the scene, the user has to photograph the scene by manually rotating the camcorder, and thus, it may not be possible to photograph the scene with a uniform distance.

Furthermore, since the tripod of the camcorder does not have a zoom button for controlling the focus of the camcorder lens, nor a record button for recording images on a recording medium, there may be difficulty in maintaining focus on the object while photographing it when moving the camcorder with one hand. Conventional tripods for other image recording devices, including, but not limited to digital cameras, single lens reflex (SLR) cameras and other devices also suffer from the same problems discussed above.

### SUMMARY OF THE INVENTION

It is, therefore, an object of the present invention to provide a tripod for an image photographing apparatus capable of providing a stable platform when photographing and rotating the image photographing apparatus, thus widening the photographing range of the image photographing apparatus.

It is another object of the present invention to provide a tripod of an image photographing apparatus, capable of recording an image and controlling the focus of a lens of the image photographing apparatus while moving the image photographing apparatus with one hand. In accordance with still another object of the present invention, there is provided a tripod of an image photographing apparatus for supporting the image photographing apparatus.

A tripod for use with the image photographing apparatus according to an embodiment of the present invention comprises a mount section to which the image photographing apparatus is attached, and a drive section for rotating the mount section. In accordance with another aspect of the present invention, there is provided a mount section comprising at least one signal terminal for transmitting a signal from the image photographing apparatus to the drive section, and a power terminal for carrying power from the image photographing apparatus to the drive section. The tripod of the image photographing apparatus, according to an exemplary embodiment of the present invention, further comprises a record button for transmitting an image record signal to the image photographing apparatus and a zoom button for transmitting a lens zoom signal to the image photographing apparatus. The exemplary embodiment of the present invention also comprises that the tripod of the image photographing apparatus includes the record button and the zoom button.

In accordance with still another embodiment of the present invention, there is provided a tripod of an image photographing apparatus for supporting the image photographing apparatus with a record button for transmitting an image record signal. The tripod of the image photographing apparatus further comprises a zoom button for transmitting a zoom signal to the image photographing apparatus.

### BRIEF DESCRIPTION OF THE DRAWINGS

The above aspects and features of the present invention will be more apparent by describing certain embodiments of the present invention with reference to the accompanying drawings, in which:

FIG. 1 is a cross-sectional view illustrating a tripod of a camcorder in accordance with an embodiment of the present invention;

FIG. 2 is a top view illustrating the tripod of the camcorder shown in FIG. 1;

FIG. 3 is a perspective view illustrating an upright state of the camcorder tripod shown in FIG. 1;

FIG. 4 is a bottom view of a camcorder attached to a camcorder tripod in accordance with an embodiment of the present invention;

FIG. 5 is a functional block diagram illustrating a connection relationship between a camcorder and a camcorder tripod in accordance with an embodiment of the present invention;

FIG. 6 is a perspective view illustrating left and right rotations of a camcorder connected to a camcorder tripod by using a remote control in accordance with an embodiment of the present invention; and

FIG. 7 is a perspective view illustrating the use of a zoom button and a record button of a camcorder tripod in accordance with an embodiment of the present invention.

### DETAILED DESCRIPTION OF THE EXEMPLARY EMBODIMENTS

Exemplary embodiments of the present invention will be described in greater detail with reference to the accompanying drawings. Particularly, a tripod of a camcorder, which is a representative image photographing apparatus, is exemplified as one preferable embodiment of a tripod of an image photographing apparatus in accordance with the present invention.

In the following description, same drawing reference numerals are used for the same elements in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail for the purpose of conciseness and clarity.

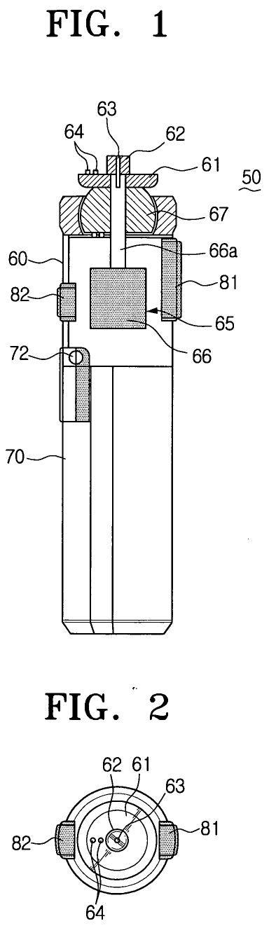

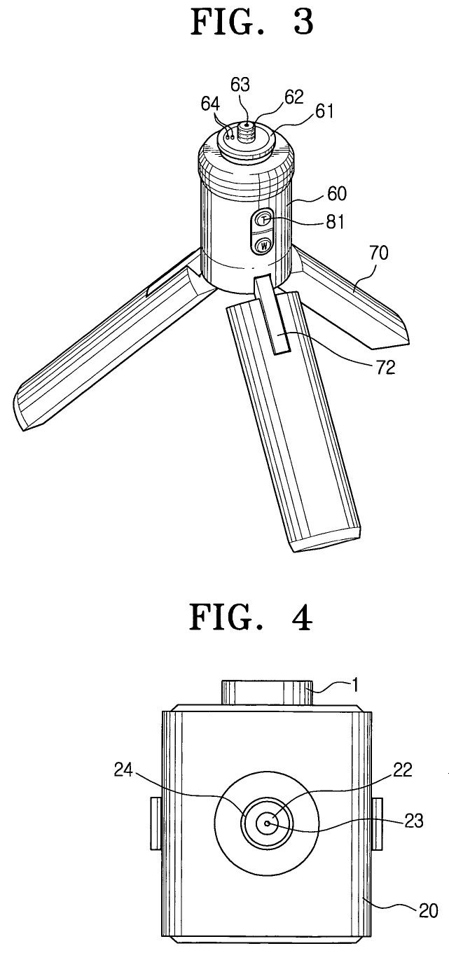

Referring to FIGS. 1 to 3, a camcorder tripod 50 in accordance with an embodiment of the present invention includes a body 60 and legs 70. Hereinafter, although the description about the image photographing apparatus is mainly based on the camcorder, which is one representative image photographing apparatus, it is apparent that the present invention can be applicable to any other image photographing apparatuses such as a camera. The body 60 has a mount unit 61 to which a camcorder is fixed, and is mounted on an upper part of the body 60 so as to rotate around the body 60 and a drive section 65 for rotating the mount section 61. The drive section 65 is formed in the body 60 and has a motor 66 that rotates a motor shaft 66a in response to a signal from a control section of the camcorder. The motor shaft 66a is connected with the mount section 61, so that the mount section 61 rotates around the body 60 once the motor shaft 66a rotates. A rotation support member 67 for supporting the rotation of the mount section 61 is placed in between the mount section 61 and the body 60. In the center of an upper surface of the mount section 61, there is a screw 62 into which a fixing tab 22 (FIG. 4) formed at a bottom surface of the camcorder 20 (FIG. 4) is screwed. A first power terminal 63 for providing power from the camcorder to the motor 66 of the drive section 65 is formed in the center of the screw 62. There are signal terminals 64 in one side of the screw 62 placed on the upper surface of the mount section 61. The signal terminals 64 are connected to the drive section 65 in order to transmit a rotation signal of the camcorder to the drive section 65. Referring to FIG. 4, a second power terminal 23 is connected with the first power terminal 63 of the mount section 61 shown in FIGS. 1 to 3, and is placed beneath the bottom of the fixing tab 22. A signal terminal contact surface 24 is formed around the fixing tab 22, and is formed in a place corresponding to the signal terminals 64 of the mount section 61 shown in FIGS. 1 to 3. Methods for making an electric connection between the first power terminal 63, the signal terminals 64 and the drive section 65 shown in FIGS. 1 to 3 are well-known to those skilled in the art of the present invention. In one exemplary embodiment, the use of a motor 66 with a motor shaft 66a having a hollow inside and a slip ring are examples of the well-known methods.

On the basis of the configuration described above, once the fixing tab 22 of the camcorder 20 is completely screwed into the screw 62 of the mount section 61 included in the camcorder tripod 50, the first power terminal 63 of the screw 62 is connected with the second power terminal 23 of the fixing tab 22, thereby supplying power from the camcorder 20 to the motor 66 of the drive section 65. Similarly, the signal terminals 64 of the mount section 61 are in contact with the signal terminal contact surface 24 of the camcorder 20, thereby transmitting a rotation signal from the camcorder 20 to the drive section 65.

As shown in FIG. 2, the body 60 of the camcorder tripod 50 can further include a zoom button 81 capable of controlling the focus of a lens section 1 of the camcorder 20 (FIG. 4) and a record button 82 that transmits a signal that commands the record section of the camcorder 20 to record an image captured by the lens section 1 of the camcorder 20 on a recording medium. The zoom button 81 and the record button 82 are placed on an outer circumference of the body 60 and are electrically connected to the signal terminals 64 of the mount section 61. Therefore, signals from the record button 82 and the zoom button 81 are transmitted to a control section of the camcorder 20 through the signal terminals 64 of the mount section 61 and the signal contact surface 24 of the camcorder 20. Then, the control section of the camcorder 20 controls the lens section 1 and the record section of the camcorder 20 in response to the transmitted signals.

The camcorder tripod 50 has three legs 70, and each leg 70 is adjoined to a bottom end of the body 60 through a hinge 72. Each leg 70 is set with an appropriate length that stably supports the camcorder 20 when the camcorder tripod 50 stands on the ground after the camcorder 20 is combined with the mount section 61. In addition, each of the legs 70 can be configured to have a hollow inner space, so that a rechargeable battery can be placed thereinto. Although the power supplied from the rechargeable battery provides the power for the main driving source of the drive section 65, the power from the rechargeable battery can still be used as supplemental power for power section of the camcorder 20. In this case, a power terminal for connecting the rechargeable battery to the drive section 65, or the first power terminal 63 in the hinge 72 disposed between the body 60 and each of the legs 70 can be provided.

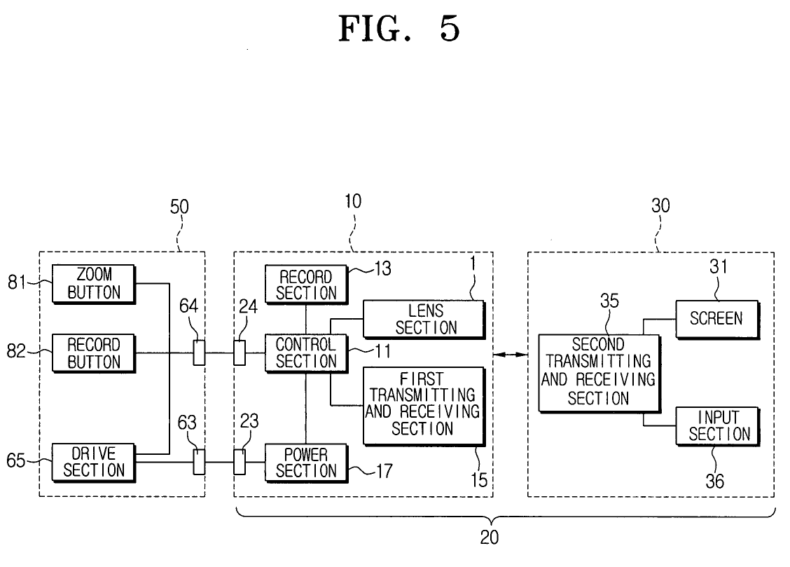

FIG. 5 is a block diagram illustrating one exemplary connection relationship between the camcorder tripod 50 and the camcorder 20 when the camcorder 20 is combined with the camcorder tripod 50 according to an embodiment of the present invention.

As shown in FIG. 5, the zoom button 81, the record button 82 and the drive section 65 are connected to the control section 11 of the camera unit 10 of the camcorder 20 through the signal terminals 64 and the signal terminal contact surface 24. The drive section 65 is also connected with a power section 17 of the camera unit 10 through the first power terminal 63 and the second power terminal 23. The camcorder 20 includes the camera unit 10 and a display unit 30. The camera unit 10 includes the lens section 1, the record section 13, the control section 11, the power section 17, and the first transmitting and receiving section 15. The display unit 30 includes a screen 31 on which an image captured by the lens section 1 is displayed, an input section 36 having a plurality of buttons for controlling the lens section 1, the record section 13, and a second transmitting and receiving section 35 for making a wired or wireless connection between the camera unit 10 and the display unit 30. Therefore, the image captured by the lens section 1 is displayed on the screen 31 of the display unit 30. The camera unit 10 of the camcorder 20 can be controlled by manipulating another zoom button and record button of the input section 36. When a rotation button included in the display unit 30 is manipulated, this signal is transmitted to the drive section 65 of the camcorder tripod 50 through the control section 11 of the camera unit 10, and as a result, the camera unit 10 rotates on the camcorder tripod 50. As described above, any camcorder that can be combined with the camcorder tripod 50 can be used as long as the control section 11 controls the drive section 65 of the camcorder tripod 50 and supplies the power to the drive section 65.

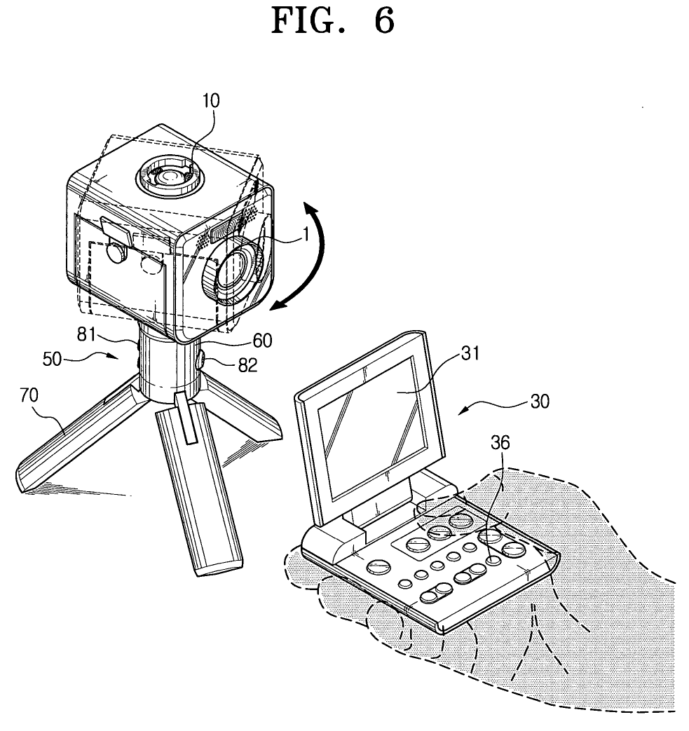

Operations of the camcorder tripod 50 having the configuration described above in accordance with an embodiment of the present invention will be described in detail with reference to the drawings. Particularly, FIG. 6 illustrates that the camcorder combined with the camcorder tripod makes left and right rotations in accordance with an embodiment of the present invention.

Referring to FIGS. 5 and 6, the camcorder combined with the mount section of the camcorder tripod 50 includes the camera unit 10 and the display unit 30 communicates wirelessly with the camera unit 10. The camera unit 10 includes the lens section 1 for capturing an image of a target object, the record section 13 for selectively recording the captured image by the lens section 1 on a recording medium, and the control section 11 for converting the captured image into an electric signal that can be displayed through the display unit 30 and controlling peripheral configuration elements. The camera unit 10 further includes a first transmitting and receiving section 15 for wirelessly transmitting the converted image signal stored in the control section 11 to the display unit 30, and for receiving a camera unit control signal generated in and transmitted from the display unit 30. The control section 11 is connected to: the signal terminal contact surface 24 that transmits the rotation signal of the camera unit 10 to the drive section 65 by the signal terminals 64 and signal terminal contact surface 24, and the power section 17 for supplying the power to the control section 11 and the control section 11 is also connected to the peripheral configuration elements. On the bottom surface of the camera unit 10, there is the fixing tab 22 (FIG. 4) combined with the mount section 61 of the camcorder tripod 50 (FIG. 1). Furthermore, the second power terminal 23 is connected to the power section 17 for the purpose of supplying power to the drive section 65, and the second power terminal 23 is formed beneath the fixing tab 22.

The lens section 1 can comprise a zoom lens capable of changing its focus length, and the zoom lens is automatically operated by a power source (not shown) in response to a signal provided from the zoom button 81. As described above, the record section 13 for recording an image captured by the lens section 1 to a recording medium includes a recording and reproducing device for recording an image signal on the recording medium and/or reproducing the recorded image signal. The record section further comprises a recording medium organizing device for putting the recording medium into a main body of the camera unit 10 or taking the recording medium out of the main body of the camera unit 10.

The control section 11 converts the captured image by the lens section 1 into an image signal that can be displayed on the screen 31, and transmits the image signal to the display unit 30 through the first transmitting and receiving section 15. The control section 11 photographs a targeted object by controlling the lens section 1 and the record section 13 in response to signals originated from various buttons of the input section 36 of the display unit 30 and received through the first transmitting and receiving section 15, or in response to a signal from the zoom button 81 and a signal from the record button 82 of the camcorder tripod 50 transmitted through the signal terminal contact surface 24. When the control section 11 receives rotation signal from the display unit 30, it controls the drive section 65 of the camcorder tripod 50 to make the camera unit 10 rotate on the camcorder tripod 50 within a predetermined angular range. The control section 11 can control the camera unit 10 to turn by a predetermined angle, or to rotate repeatedly within a predetermined range of angle.

The first transmitting and receiving section 15 wirelessly transmits the image signal converted by the control section 11 to the display unit 30. The first transmitting and receiving section 15 receives a camera unit control signal wirelessly transmitted from the second transmitting and receiving section 35 and then transmits the camera unit control signal to the control section 11. The first transmitting and receiving section 15 can be any type of wireless transmitting and receiving modules capable of transmitting and receiving data signals image signals, voice signals and the like. Among the numerous type of wireless transmitting and receiving modules, a Bluetooth module, which is a wireless local area network, can be used in an exemplary embodiment of the present invention.

As illustrated in FIG. 6, the fixing tab 22 of the camera unit 10 of the camcorder configured as described above is screwed into the screw 62 (FIG. 2) of the camcorder tripod 50, and then the three legs 70 of the camcorder tripod 50 are stretched out to stand on the ground. The rotation button of the input section 36 of the display unit 30 can be manipulated to make the camera unit 10 rotate in right and left directions with respect to the camcorder tripod 50. This left and right rotation of the camera unit 10 is illustrated in FIG. 6. A user can selectively record a desired image while viewing an image displayed on the screen 31 of the display unit 30. The camera unit 10 can also record images in a wide range of views (e.g., a panoramic picture) by recording several images captured by the lens section 1 while the camera unit 10 rotates around the camcorder tripod 50.

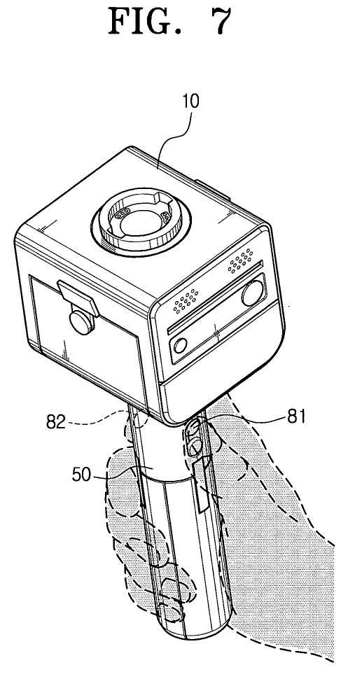

In accordance with another embodiment of the present invention, the three legs 70 of the camcorder tripod 50 can be folded inward, and the camcorder tripod 50 with the inwardly folded legs 70 can be used as a handle for photographing as depicted in FIG. 7. As shown in FIG. 7, the user can grab the display unit 30 with one hand while concurrently viewing a displayed image on the screen 31. The user can simultaneously grab the camcorder tripod 50 with the other hand and directs the lens section 1 to a target object. The zoom button 81 formed in the body 60 of the camcorder tripod 50 can be manipulated by a thumb of the hand that grabs the camcorder tripod 50, and the lens section 1 can therefore be easily focused. Once the lens section 1 is in focus, the record button 82 formed in the body 60 of the camcorder tripod 50 can be pressed by an index finger that grabs the camcorder tripod 50 to record the image captured by the lens section 1.

In accordance with still another embodiment of the present invention, the image photographing apparatus as described above can make left and right rotations at a predetermined angle with respect to a tripod of the image photographing apparatus. Also, the image photographing apparatus is capable of making repetitive rotations at a predetermined angle. As a result, it is possible to obtain the effect of photographing images with a great deal of stability in a wide range of view.

In accordance with further embodiment of the present invention, a user can manipulate the lens section 1 of the camera unit and record images while holding the tripod of the image photographing apparatus with one hand. Accordingly, the tripod of the image photographing apparatus can be more conveniently used.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A tripod of an image photographing apparatus for supporting the image photographing apparatus, the tripod of the image photographing apparatus comprising:
a mount section to which the image photographing apparatus is attached; and
a drive section for rotating the mount section.

2. The tripod of the image photographing apparatus of claim 1, wherein the mount section comprises:
at least one signal terminal for transmitting a signal from the image photographing apparatus to the drive section; and
a power terminal for carrying power from the image photographing apparatus to the drive section.

3. The tripod of the image photographing apparatus of claim 1, further comprising:
a record button for transmitting an image record signal to the image photographing apparatus.

4. The tripod of the image photographing apparatus of claim 1, further comprising:
a zoom button for transmitting a lens zoom signal to the image photographing apparatus.

5. A tripod of an image photographing apparatus for supporting the image photographing apparatus, the tripod of the image photographing apparatus comprising:
a record button for transmitting an image record signal to the image photographing apparatus.

6. The tripod of the image photographing apparatus of claim 5, further comprising:
a zoom button for transmitting a lens zoom signal to the image photographing apparatus.

7. An image photographing system, comprising:
an image photographing apparatus;
a wireless controller; and
a tripod, comprising,
a mount section to which the image photographing apparatus is attached; and
a drive section for rotating the mount section.

8. The image photographing system according to claim 7, wherein the mount section comprises:
at least one signal terminal for transmitting a signal from the image photographing apparatus to the drive section; and
a power terminal for carrying a power of the image photographing apparatus to the drive section.

9. The image photographing system according to claim 7, wherein the tripod further comprises:
a record button for transmitting an image record signal to the image photographing apparatus.

10. The image photographing system according to claim 7, wherein the tripod further comprises:
a zoom button for transmitting a lens zoom signal to the image photographing apparatus.

11. The image photographing system according to claim 7, wherein the wireless controller comprises:
a transmitting/receiving section for transmitting control signals, including a rotation command signal, to the image photographing apparatus;
a screen for displaying an image captured by the image photographing apparatus; and
an input section for receiving commands from a user of the image photographing apparatus.
